(19) United States
(12) Patent Application Publication
(10) Pub. No.: US 2021/0132425 A1
(43) Pub. Date: May 6, 2021

(54) TOUCH SENSOR LIQUID CRYSTAL DISPLAY DEVICE WITH ANTISTATIC COATING METHOD

(71) Applicant: CORNING INCORPORATED, CORNING, NY (US)

(72) Inventors: Idrani Bhattacharyya, Ithaca, NY (US); Jr-Nan Hu, New Taipei City (TW); Tomohiro Ishikawa, Corning, NY (US); Robert George Manley, Vestal, NY (US); Jonathan Michael Mis, Horseheads, NY (US); Vitor Marino Schneider, Painted Post, NY (US); Dean Michael Thelen, Addison, NY (US); Sujanto Widjaja, Palo Alto, CA (US); Nikolay Zhelev Zhelev, Painted Post, NY (US)

(21) Appl. No.: 16/491,900

(22) PCT Filed: Oct. 31, 2017
(86) PCT No.: PCT/US17/59169

§ 371 Date: Sep. 6, 2019

(51) Int. Cl. G02F 1/1333; G02F 1/1335; G02F 1/1368

(52) U.S. Cl. CPC G02F 1/13338; G02F 1/133528; G02F 2202/22; G02F 1/133514; G02F 1/133331; G02F 1/1368

(57) ABSTRACT

Disclosed devices (100) include a liquid crystal layer (140), a cover glass (105), a polarizer (115), and at least one anti-static coating disposed on at least one major surface (105A, 105C) of the cover glass, at least one major surface (115A, 115C) of the polarizer, or both. Methods for reducing mura (light leakage) in a touch-display device by means of this anti-static coating are also disclosed.

### CROSS-REFERENCE TO RELATED APPLICATIONS

This application claims the benefit of priority under 35 U.S.C. § 119 of U.S. Provisional Application Ser. No. 62/469,102 filed on Mar. 9, 2017, and U.S. Provisional Application Ser. No. 62/531,124 filed on Jul. 11, 2017, the content of each is relied upon and incorporated herein by reference in its entirety

### FIELD OF THE DISCLOSURE

The disclosure relates generally to displays having reduced electrostatic surface charge and methods for reducing surface charge in such displays, and more particularly to displays including at least one anti-static layer to reduce mura and/or unintended liquid crystal modulation caused by the build-up of electrostatic charge.

### BACKGROUND

Displays with a thin film transistor (TFT) liquid crystal display (LCD) are commonly incorporated into touchscreen devices such as smartphones. TFT LCDs typically have liquid crystals, TFTs, a VCOM layer, and a color filter arranged between a color filter glass and a TFT array glass. A polarizer and a cover glass are also typically arranged above the color filter glass. One or more touch sensors may also be included in a display to provide combined touch and display functionality, referred to herein as a “touch-display” assembly, such as an LCD touch screen.

LCD touch screens can be arranged in various configurations, including “on-cell,” “in-cell,” or “in-cell hybrid” configuration. In an on-cell configuration the touch sensor is disposed on an outer surface of the color filter glass, e.g., a surface facing the user. In an in-cell configuration the touch sensor is disposed within the cell, e.g., between the TFT array glass and the color filter glass. An in-cell hybrid configuration can comprise receive (RX) sensor layers arranged in a y direction and transmit (TX) sensor layers arranged in the x direction. The RX sensor layer is disposed on an outer surface of the color filter glass and the TX sensor layer is combined with the VCOM layer and is disposed between the color filter glass and the TFT array glass. Thus an exemplary in-cell hybrid display would at least include: a TFT array glass; TFTs disposed on the TFT array glass; the combined VCOM and TX sensor layer disposed on the TFTs; the liquid crystal layer disposed on the combined VCOM and TX sensor layer; the color filter disposed on the liquid crystal layer; the color glass filter disposed on the color filter; the RX sensors layer disposed on the color filter glass; a polarizer disposed on the RX sensors layer, and a cover glass disposed on the polarizer.

When static electricity is created on the cover glass bonded to an in-cell hybrid display, for example by moving a finger across the cover glass, and electrostatic charge builds up and creates an electric field between the RX sensor layer and the TX sensor layer. The electric field can lead to unintentional modulation of the liquid crystal layer which, in turn, leads to light leakage, also referred to herein as mura. As such, there is a need to solve the problem of this mura induced by electrostatic charge building up on the cover glass.

### SUMMARY

The disclosure relates, in various embodiments, to devices comprising a liquid crystal layer, a cover glass, a polarizer positioned between the liquid crystal layer and the cover glass, and a coating comprising at least one anti-static agent disposed on at least one major surface of the cover glass, at least one major surface of the polarizer, or both. Display, electronic, and lighting devices comprising such devices are also disclosed herein.

In non-limiting embodiments, the coating may be disposed on at least a portion of a first major surface and/or a second major surface of the cover glass. In additional embodiments, the coating may be disposed on at least a portion of a first major surface and/or a second major surface of the polarizer. In further embodiments, the coating may be disposed on at least one major surface of the cover glass and at least one major surface of the polarizer. According to certain embodiments, the coating can have a thickness ranging from about 1 nm to about 5000 nm. The at least one anti-static agent can be chosen, for example, from cationic and anionic polymers and/or cationic and anionic surfactants, such as polycationic polymers and quaternary ammonium compounds.

In non-limiting embodiments, the device may comprise one or more additional layers, such as a first adhesive layer positioned between the cover glass and the polarizer and/or a second adhesive layer positioned between the polarizer and the liquid crystal layer. Additional components include, for instance, at least one of a receive (RX) sensor layer, a transmit (TX) sensor layer, a thin film transistor (TFT) array, a color filter glass, a color filter, and an anti-fingerprint layer. According to further embodiments, the device may be a liquid crystal touch-display with an in-cell hybrid configuration. The device may have, in various embodiments, have an electrostatic discharge decay time constant of less than about 1 second. In certain embodiments, the at least one coated major surface of the cover glass or polarizer can have a surface resistivity ranging from about 10⁵ to about 10¹¹ Ohm/sq.

Further disclosed herein are methods for reducing mura in a touch-display device, the methods comprising positioning a polarizer between a cover glass and a liquid crystal layer and applying a coating comprising at least one anti-static agent to at least one major surface of the cover glass, at least one major surface of the polarizer, or both. The step of applying the coating can comprise, for example, applying a solution comprising the at least one anti-static agent and at least one solvent to the at least one major surface and optionally drying the solution to remove the at least one solvent. A concentration of the at least one anti-static agent in the solution can range, for example, from about 0.0001 wt % to about 50 wt %.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts.

FIG. 1 depicts an exemplary touch-display device;

FIGS. 2A-B demonstrate the effect of electrostatic charge on liquid crystal alignment;

FIGS. 3A-D depict assemblies comprising one or more anti-static coatings according to various embodiments of the disclosure;

FIGS. 4A-B are potential maps of an uncoated glass surface at different times after tribo-charge generation;

FIGS. 5-6 are graphs illustrating electrostatic charge on a glass surface after tribo-charging for coated and uncoated glass samples;

FIGS. 7A-B are graphs illustrating integrated surface voltage as a function of time for coated and uncoated glass samples;

FIGS. 8A-B are graphs illustrated electric field as a function of time for coated and uncoated glass samples;

FIG. 9 is a graph illustrating film thickness as a function of anti-static solution concentration;

FIG. 10 is a bar chart of sheet resistance for uncoated glass samples and glass samples coated with varying concentrations of anti-static agent; and

FIGS. 11A-D illustrate schematics for various experimental set-ups disclosed herein.

### DETAILED DESCRIPTION

Disclosed herein are devices comprising a liquid crystal layer, a cover glass, a polarizer positioned between the liquid crystal layer and the cover glass, and a coating comprising at least one anti-static agent disposed on at least one major surface of the cover glass, at least one major surface of the polarizer, or both. Also disclosed herein are methods for reducing mura in a touch-display device, the methods comprising positioning a polarizer between a cover glass and a liquid crystal layer and applying a coating comprising at least one anti-static agent to at least one major surface of the cover glass, at least one major surface of the polarizer, or both.

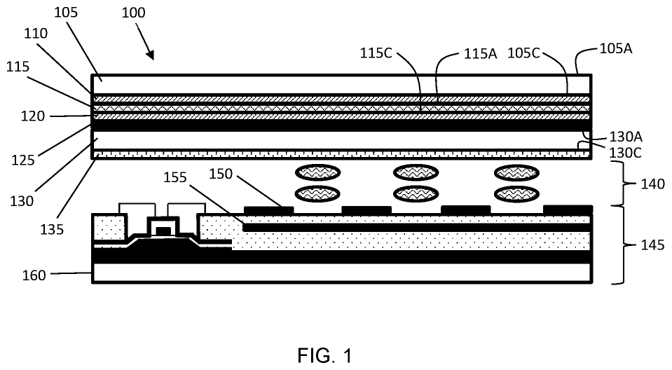

Various embodiments of the disclosure will now be discussed with reference to FIGS. 1-11, which illustrate various embodiments of the disclosure. The following general description is intended to provide an overview of the claimed devices and methods, and various embodiments will be more specifically discussed throughout the disclosure with reference to the non-limiting depicted embodiments, these embodiments being interchangeable with one another within the context of the disclosure.

FIG. 1 illustrates a non-limiting example of a display device 100 having an in-cell hybrid configuration. The display device may include, for example, a cover glass 105, a polarizer 115, an RX sensor layer 125, a liquid crystal layer 140, and a TFT assembly 145. The cover glass 105 can include a first major surface 105A and a second major surface 105C. The polarizer 115 can likewise include a first major surface 115A and a second major surface 115C. In non-limiting embodiments, the display device 100 may be oriented such that the first major surfaces disclosed herein (105A, 115A, etc.) are forward-facing, e.g., facing toward a user, whereas the second major surfaces disclosed herein (105C, 115C, etc.) are rear-facing, e.g., facing toward the back of the device. Of course, the configuration illustrated in FIG. 1 is exemplary only and is not intended to be limiting on the appended claims.

The term “positioned between” and variations thereof is intended to denote that a component or layer is located between the listed components, but not necessarily in direct physical contact with those components. For instance, the polarizer 115 is positioned between the RX sensor layer 125 and cover glass 105 as illustrated in FIG. 1, but is not in direct physical contact with either of these layers. However, a component positioned between two listed components may also, in certain embodiments, be in direct physical contact with one or more of the listed components. As such, a component A positioned between components B and C may be in direct physical contact with component B, in direct physical contact with component C, or both.

In various embodiments, additional components and/or layers may be present in the display device 100. Referring again to the non-limiting embodiment depicted in FIG. 1, the display device 100 may include a first adhesive layer 110 positioned between cover glass 105 and polarizer 115. In various embodiments, first adhesive layer 110 may be in direct physical contact with both the cover glass 105 (e.g., second major surface 105C) and the polarizer 115 (e.g., first major surface 115A), such that a bond is formed between these components. A second adhesive layer 120 may also be positioned between the polarizer 115 and the RX sensor layer 125. According to non-limiting embodiments, the second adhesive layer may be in direct physical contact with both the polarizer 115 (e.g., second major surface 115C) and the RX sensor layer 125, such that a bond is formed between these components.

In the in-cell hybrid configuration illustrated in FIG. 1, the RX sensor layer 125 may be disposed on the first major surface 130A of color filter glass 130. A color filter 135 may be disposed on the second major surface 130C of the color filter glass 130. The liquid crystal (LC) layer 140 may, in some embodiments, be positioned between the color filter glass 130 and the TFT assembly 145. The LC layer 140 may be in direct contact with the color filter 135 and the TFT assembly 145, or one or more optional components and/or layers may be present therebetween, such as adhesive layers and the like. An exemplary LC layer 140 may include any type of liquid crystal material arranged in any configuration known in the art, such as a TN (twisted nematic) mode, a VA (vertically aligned) mode, an IPS (in plane switching) mode, a BP (blue phase) mode, a FFS (Fringe Field Switching) mode, and an ADS (AdvancedSuper Dimension Switch) mode, to name a few.

The TFT assembly 145 can comprise various components and/or layers, such as a layer of individual pixel electrodes and a common voltage (VCOM) electrode layer shared by all pixels. In the illustrated in-cell hybrid configuration, the transmit (TX) sensor layer 155 may also serve as the common voltage (VCOM) electrode layer and thus, may be interchangeably referred to herein as the TX/VCOM layer. Together with pixel electrodes 150, the TX/VCOM layer 155 can generate an electric field upon application of voltage across the electrodes. This electric field can determine the orientation direction of liquid crystal molecules in the liquid crystal layer 140. A TFT glass 160 may be used as a support for the various components of the TFT array.

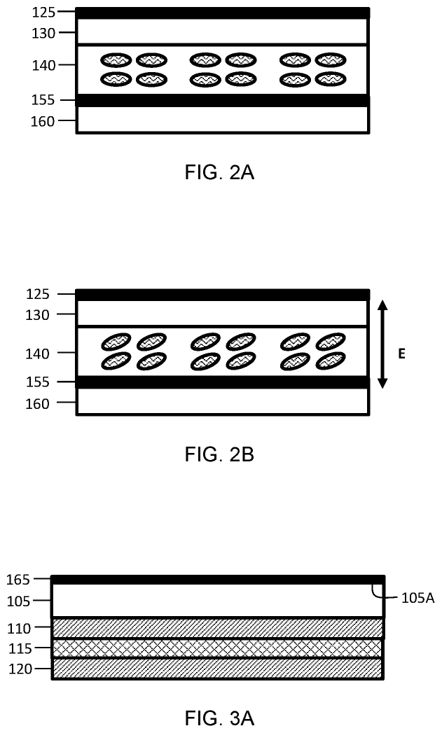

Referring now to FIGS. 2A-B, a mechanism is shown by which static electricity can develop mura in LC display devices. FIG. 2A depicts a simplified LC display device in its initial state, e.g., prior to exposure to static electricity. The LC layer 140 in FIG. 2A is properly aligned and blocks light from undesirably leaking through to the user. When static electricity is created in the device, for example, when a finger is moved across the cover glass, when a protective coating is peeled off the cover glass, or other like motions, an electrostatic charge may develop. As shown in FIG. 2B, the electrostatic charge generates a vertical electric field E between the RX sensor layer 125 on the color filter glass 130 and the TX sensor layer 155 on the TFT glass 160. The electric field E causes the liquid crystals in the LC layer 140 to spin undesirably and light is no longer blocked in those locations, resulting in localized regions of mura. The user may perceive, for example, cloudiness, color distortion, and/or a reduction in local contrast and/or brightness in the regions of the display corresponding to the misaligned liquid crystals.

An electric field generated by electrostatic surface charge, such as that illustrated in FIG. 2B, can impact the LC orientation within a LC display device. Such a reorientation can manifest as mura (light leakage) visible to the user. Two factors can impact mura: relaxation time of charge and amount of charge. If the charge relaxation time exceeds that of the LC director (approx. 10⁻²-10⁻¹ s) or if the amount of charge exceeds the threshold value of the LC director, the LC will reorient in response to the field. Mura can often have a transient nature with a characteristic time of 10⁻¹-10² seconds and can be affected by various factors such as size of the LC panel, gray level, and LC mode. In case of very high relaxation time and/or charge amount, mura retention can last as long as 10²-10³ seconds. In such cases, the relaxation time is no longer controlled by the viscous torque of the LC director and is instead controlled by the movement and adsorption of impurity ions and associated DC field within the LC cell, resulting in image sticking. One possible scenario for image sticking is a combination of repeated static charges with long relaxation times that lead to a cumulative impact.

To avoid the temporary period of liquid crystal misalignment depicted in FIG. 2B, it may be desirable to reduce, eliminate, or otherwise neutralize any electrostatic charge in the display device before such charge affects the LC layer 140. In some embodiments, an anti-static coating may be disposed on at least one major surface of the cover glass and/or on at least one major surface of the polarizer to reduce or eliminate electrostatic charge. In other embodiments, an anti-static coating may be disposed on at least one major surface of an adhesive layer within the device, e.g., an adhesive layer positioned between the cover glass and the LC layer. An adhesive layer coated one or both major surfaces with anti-static coating may, for instance, be positioned between the cover glass and the polarizer, between the polarizer and the LC layer, or both. In certain embodiments, the devices disclosed herein can reduce or eliminate electrostatic charge generation and/or quickly dissipate electrostatic charge such that the LC electric field threshold is not reached and the LC layer is not undesirably modulated by the electrostatic charge. Several different embodiments for reducing the build-up of static electricity, and the associated electrostatic charge, are discussed below.

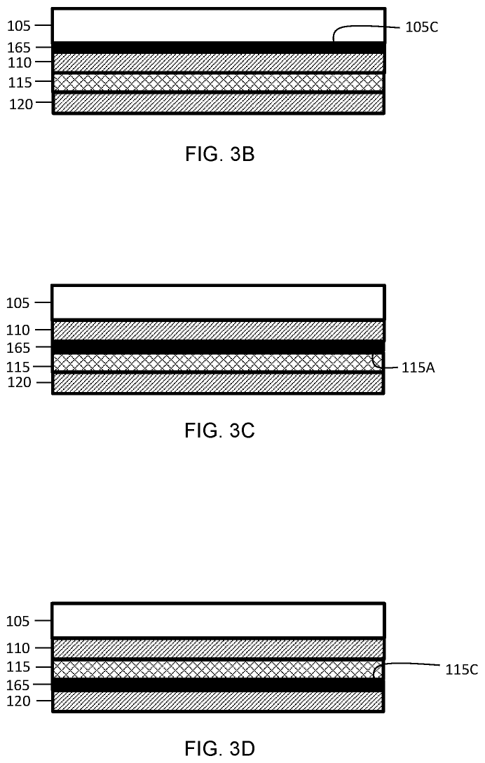

For illustrative purposes, FIGS. 3A-D depict cross-sectional views of the cover glass 105, first adhesive layer 110, polarizer 115, and second adhesive layer 120 of an exemplary display assembly. However, it is to be understood that the depicted embodiments can also comprise any other components and/or layers depicted in FIG. 1 or otherwise described herein, or any combination thereof without limitation. Embodiments of the disclosure will be discussed below with reference to FIGS. 3A-D.

As shown in FIG. 3A, an anti-static coating 165 comprising at least one anti-static agent may be disposed on at least a portion of the first major surface 105A of the cover glass 105. With reference to FIG. 3B, the anti-static coating 165 may also be disposed on at least a portion of the second major surface 105C of the cover glass 105. While FIGS. 3A-B illustrate the anti-static coating 165 covering the entire first major surface 105A and second major surface 105C, respectively, it is to be understood that such a layer may be disposed on only a portion of the first and/or second major surface, e.g., on a central or peripheral portion of the surface, or applied to any other portion of the surface in any desired pattern. Additionally, in various embodiments, the anti-static coating 165 may be applied to both the first and second major surfaces 105A, 105C, or portions thereof.

As depicted in FIG. 3C, the anti-static coating 165 may additionally or alternatively be disposed on at least a portion of the first major surface 115A of the polarizer 115. With reference to FIG. 3D, the anti-static coating 165 may also be disposed on at least a portion of the second major surface 115C of the polarizer 115. While FIGS. 3C-D illustrate the anti-static coating 165 covering the entire first major surface 115A and second major surface 115C, respectively, it is to be understood that such a layer may be disposed on only a portion of the first and/or second major surface, e.g., on a central or peripheral portion of the surface, or applied to any other portion of the surface in any desired pattern. Additionally, in various embodiments, the anti-static coating 165 may be applied to both the first and second major surfaces 115A, 115C, or portions thereof.

While FIGS. 3A-D illustrate only one anti-static coating 165, it is possible to include two or more anti-static coatings, such as three or more, four or more, and so on. In some embodiments, the anti-static coating may be applied to any two or more of major surfaces 105A, 105C, 115A, or 115C, or any portion thereof, without limitation. Although not illustrated, it is also possible to apply an anti-static coating 165 to one or both major surfaces of the first adhesive layer 110 or the second adhesive layer 120. Anti-static coating(s) on the adhesive layer(s) 110, 120 may be used alone or in conjunction with any of the anti-static coatings illustrated in FIGS. 3A-D. In some embodiments, the anti-static coating 165 may be grounded to improve the effectiveness in dissipating the static electricity, e.g., the perimeter edges of the coating may be grounded.

The terms “first” and “second” major surfaces may be used herein interchangeably to refer to opposing major surfaces of a component. In some embodiments, a “first” major surface may denote a front surface facing an intended user, e.g., emitting light toward or displaying an image to a user. Similarly, a “second” major surface may denote a rear surface facing away from the user, e.g., towards a rear panel of a device, if present.

The anti-static coating 165 may comprise at least one anti-static agent chosen from organic and inorganic compounds. The anti-static agent may function to reduce mura in the display device by reducing charge generation on the cover glass and/or by more quickly dissipating charge within the device. As used herein, the term “anti-static agent” is intended to refer to any compound that increases the electrical conductivity of the surface to which it is applied, either alone or when contacted with atmospheric humidity. Anti-static agents include, but are not limited to, ionic polymers and ionic surfactants, e.g., cationic polymers, anionic polymers, cationic surfactants, and anionic surfactants. Exemplary compounds can be chosen from, for example, quaternary ammonium compounds, aliphatic amines, ethoxylated aliphatic amines, phosphoric acid esters, polyethylene glycol esters, glycerol esters, polyols, alkyl phenols, polyaniline, polythiophene, and poly(3,4-ethylenedioxythiophene)-polystyrene sulfonate (PEDOT:PSS), to name a few. Commercially available anti-static agents can include, for example, polycationic compounds such as Luviquat™ FC 550 (containing a quaternary copolymer of 1-vinyppyrrolidone and 3-methyl-1-vinylimidazolium chloride) and other like polyelectrolytes, ACL Staticide® (containing quaternary ammonium nitrates of coco alkylbis (hydroxyethyl)methyl), KILLSTAT from Bondline, ECO 3X from Nordost, and other like products.

Ionic polymers, such as polycationic polymers, can be highly hydrophilic and soluble in water due to a strong interaction between the repeating charges along the polymer chain and the dipoles of water. Water-soluble cationic surfactants, such as quaternary ammonium compounds, can also be soluble in water due to a strong interaction between the cationic head-group of the surfactant molecule and the dipoles of water. As such, in some embodiments, aqueous solutions comprising the ionic polymers and/or cationic surfactants and at least one solvent can be prepared and applied to the cover glass and/or polarizer using any suitable method known in the art, e.g., spray coating, spin coating, dip coating, roller coating, and the like. In some embodiments, the at least one solvent may be chosen from water or water-miscible solvents. In further embodiments, the at least one solvent may not be chosen from organic solvents.

The electrostatic attraction between the glass surface and the cationic compounds can enable a high-throughput coating process. Glass surfaces can have a negative charge when in contact with aqueous solutions with a pH above about 2. For instance, in neutral or near neutral conditions (pH of about 7), the glass surface can have a significant net negative charge due to deprotonation of surface hydroxyl groups (Si—OH). The Si—OH groups act as proton donors (acidic) and can lead to negative Si—O⁻ groups on the glass surface. The electrostatic attraction between the negative glass surface and positively charged cationic compounds can enable fast adsorption of the molecules to the glass surface, which can in turn allow for a high-throughput coating process. In the case of a polarizer, which can comprise various polymeric layers, the hydrophilic nature of the outer polymeric layer(s) such as triacetyl cellulose (TAC), can similarly enable fast adsorption of the anti-static agent on the surface and, thus, a high-throughput coating process.

In various embodiments, a thickness of the anti-static coating 165 can range from about 1 nm to about 5000 nm, such as from about 5 nm to about 4000 nm, from about 10 nm to about 3000 nm, from about 20 nm to about 2000 nm, from about 30 nm to about 1000 nm, from about 40 nm to about 500 nm, from about 50 nm to about 400 nm, from about 60 nm to about 300 nm, from about 70 nm to about 200 nm, or from about 80 nm to about 100 nm, including all ranges and subranges therebetween. According to certain embodiments, the anti-static coating can be mechanically and/or thermally durable, e.g., able to withstand repeated abrasions and/or temperatures as high as about 200° C. In further embodiments, the anti-static coating does not interfere with the touch sensitivity of the cover glass, e.g., when incorporated into a touch-display device. The anti-static coating may furthermore not significantly change the color optical properties of the cover glass, polarizer, and/or device into which it is incorporated. For instance, any color change ΔE between the coated and uncoated component, as measured using the CIELAB standard (ΔE=sqrt(ΔL²+Δa²+Δb²)) is less than or equal to 10, such as less than or equal to 5, less than or equal to 3, less than or equal to 2, or less than or equal to 1, including all ranges and subranges therebetween.

In some embodiments, the anti-static coating 165 may be positioned on the first major (front) surface 105A of the cover glass 105 and may thus be contacted by a user. In such embodiments, generation of electrostatic charge may be reduced or eliminated, e.g., when the surface is rubbed, when a protective plastic film is removed, or when the surface is otherwise charged by user interaction. In some embodiments, the anti-static coating may be organic and can act as an insulating layer to prevent charge transfer from one surface to another. Without wishing to be bound by theory, charge transfer may be prevented by a reduction in accessible low energy empty electronic states where electron transfer could otherwise occur during mechanical action through triboelectrification. In additional embodiments, the anti-static coating may be hydrophilic and can form an adsorbed water layer upon contact with atmospheric humidity. The adsorbed water layer on the anti-static coating can facilitate charge dissipation such that charge accumulation is virtually unobservable.

In additional embodiments, the anti-static coating 165 is positioned on the second major (rear) surface 105C of the cover glass 105 and may thus serve as a charge sink, which routes the electrostatic charge towards the edges of the glass sheet and away from the region(s) where it may interfere with the LC layer under the cover glass. Electrostatic charge generated on the cover glass surface can be conducted through the bulk of the glass and/or across the surface. To estimate if conduction through the bulk glass is significant, we can consider the current density at an infinitesimal distance right below a charged region of charge density σ. From Ohm's law:

$$\frac{d σ}{dt} = - J = - E / ρ ,$$

where E=σ/ε and ρ and ε are the resistivity and dielectric constant of the glass, respectively. Thus,

$$\frac{d σ}{dt} = - \frac{1}{ρ ɛ} σ ,$$

which leads to the conclusion that the time constant for conduction is determined as the product of the resistivity and the dielectric constant. Glass Permittivity (i.e., dielectric constant times vacuum permittivity) for glass is typically between 3×10⁻¹¹ and 10⁻¹⁰ F/m. To have a time constant of 1-10 s for bulk conduction, a glass resistivity on the order of 10¹³ Ohm*cm is targeted, which is the case for Gorilla® Glasses 3 and 5, disclosed herein as exemplary cover glasses. Other exemplay glasses for the cover glass include alkali containing glasses and alkali containing glass ceramics within or below the above resistivity range, and hence having significant conduction through their bulk.

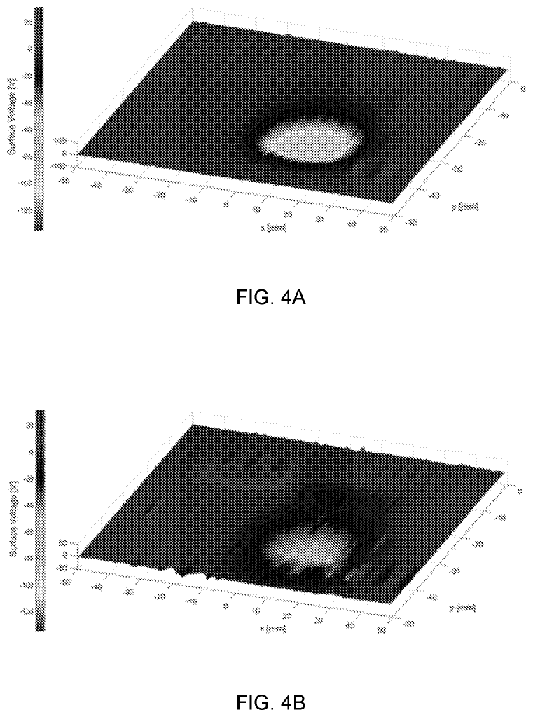

Evidence for charge conduction through the bulk of the glass is also illustrated in FIGS. 4A-B, which are potential maps of an uncoated Gorilla® Glass 5 surface after a tribo-charge is generated by rubbing the glass surface. The map in FIG. 4A was generated by scanning the surface at t=4.45 seconds, where t=0 represents the time of charge generation. The scan was finished at t=80.172 seconds. Average surface voltage over the vicinity of the interrogated area was −211.0 V. The map in FIG. 4B was generated by starting a surface scan at t=84.352 second and finishing the scan at t=160.072 seconds. Average surface voltage over the vicinity of the interrogated area was −147.6 V. The potential maps show very little sign of lateral spreading of charge hotspots, indicating low charge transport via the surface. However, the surface potential decreases with time, indicating that the charge is being transported through the bulk of the glass under the affected region.

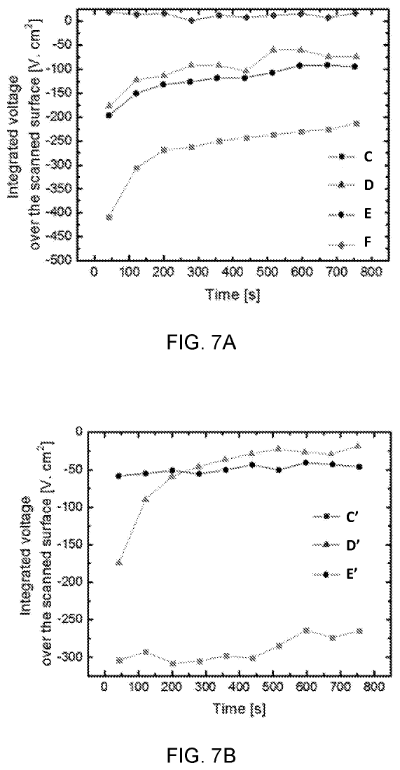

Further evidence for charge conduction through the bulk of the glass is provided in FIGS. 7A-B, discussed in more detail below. Integrated voltage ∫VdA over the scanned surface (which is larger than the area over which the charge is generated) is no more than 400 V-cm², whereas the amount of charge imparted on the glass (measured by the electrometer) is ˜50 nC. If the charge resides on the surface of the glass (no conduction through bulk), from parallel plate capacitor approximation (relevant for thin samples, e.g. d=0.7 mm thick), we can convert integrated voltage over the area to surface charge using:

$$Q = \frac{ɛ}{d} \int VdA \leq 4 n C ,$$

which is more than 10 times less than the amount of charge generated. FIGS. 7A-B therefore indicate that a significant amount of electrostatic charge is conducted through the bulk of the glass. FIGS. 7A-B also demonstrate that coatings on the rear (non-contact) surface can reduce the integrated voltage on the front (contact) surface of the cover glass by conducting it away from the area after the charge travels through the bulk of the glass to the rear surface.

FIGS. 4A-B and 7A-B demonstrate that a majority of the charge does not leave the glass through surface conduction. However, by increasing the conductivity of one or more surfaces in the device, it may be possible to increase the amount of charge conducted on the surface such that the charge can be re-routed to the support rather than penetrating the device and coming into proximity with the LC layer.

In further embodiments, the anti-static coating 165 may be positioned on the first or second major surface 115A, 115C of the polarizer 115 and may thus serve as a conductive shielding layer between the charged cover glass 105 and the liquid crystal layer 140. The anti-static coating 165 may also help to dissipate the electrostatic charge more quickly, which can reduce any localized high electric potential and the resulting large electric fields across the liquid crystal layer 140.

According to various embodiments, at least one of the cover glass 105, first adhesive layer 110, second adhesive layer 120, RX sensor layer 125, color filter glass 130, pixel electrodes 150, TX/VCOM layer 155, and TFT glass 160 may be optically transparent. In other embodiments, the anti-static coating 165 may be optically transparent. As used herein, the term “transparent” is intended to denote that the component and/or layer has a transmission of greater than about 80% in the visible region of the spectrum (˜400-700 nm). For instance, an exemplary component or layer may have greater than about 85% transmittance in the visible light range, such as greater than about 90%, or greater than about 95%, including all ranges and subranges therebetween. The first and second adhesive layers 110, 120 may comprise optically clear adhesives, which may be in the form of adhesive films or adhesive liquids. Non-limiting exemplary thicknesses of the first and/or second adhesive layers 110, 120 may range from about 50 μm to about 500 μm, such as from about 100 μm to about 400 μm, or from about 200 μm to about 300 μm, including all ranges and subranges therebetween. The RX sensor layer 125, pixel electrodes 150, and/or TX/VCOM layer 155 may comprise transparent conductive oxides (TCOs), such as indium tin oxide (ITO) and other like materials. The TX/VCOM layer may also comprise a conductive mesh, e.g., comprising metals such as silver nanowires or other nanomaterials such as graphene or carbon nanotubes.

In non-limiting embodiments, the cover glass 105, color filter glass 130, and/or the TFT glass 160 may comprise optically transparent glass sheets. The glass sheets can have any shape and/or size suitable for use in a display device, such as an LCD touch screen. For example, the glass sheet can be in the shape of a rectangle, square, or any other suitable shape, including regular and irregular shapes and shapes with one or more curvilinear edges.

According to various embodiments, the glass sheets can have a thickness of less than or equal to about 3 mm, for example, ranging from about 0.1 mm to about 2 mm, from about 0.3 mm to about 1.5 mm, from about 0.5 mm to about 1.2 mm, or from about 0.7 mm to about 1 mm, including all ranges and subranges therebetween. According to various embodiments, the glass sheets can have a thickness of less than or equal to 0.3 mm, such as 0.2 mm, or 0.1 mm, including all ranges and subranges therebetween. In certain non-limiting embodiments, the glass sheets can have a thickness ranging from about 0.3 mm to about 1.5 mm, such as from about 0.5 to about 1 mm, including all ranges and subranges therebetween.

The glass sheets may comprise any glass known in the art for use in a display, such as an LCD touch screen, including, but not limited to, soda-lime silicate, aluminosilicate, alkali-aluminosilicate, borosilicate, alkaliborosilicate, aluminoborosilicate, alkali-aluminoborosilicate, and other suitable glasses. The glass sheets may, in various embodiments, be chemically strengthened and/or thermally tempered. Non-limiting examples of suitable commercially available glasses include EAGLE XG®, Lotus™, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

In some embodiments, the cover glass 105 may have one or more additional coatings on the first and/or second major surfaces 105A, 105C, which can serve various functions. For example, at least a portion of the first major surface 105A of the cover glass 105 can be coated with one or more of an anti-fingerprint, anti-smudge, anti-glare, or anti-reflective layer which can, in some embodiments, be non-conductive. In some embodiments, an anti-fingerprint coating may include a buffer layer of SiO₂ and a flourosilane layer. When a user's finger moves across the cover glass with a non-conductive additional coating, static electricity can build up and cannot be quickly dissipated through the non-conductive additional coating. In some embodiments, the anti-static coating 165 may be placed between the additional coating(s) and the first major surface 105A of the cover glass 105 to dissipate electrostatic charge. Alternatively or additionally, the anti-static coating may be applied to any one or more of surfaces 105C, 115A, and/or 115C, or portions thereof.

According to various embodiments, the anti-static coatings disclosed herein may reduce or eliminate electrostatic charge generation such that the electric field threshold for modulating the LC layer is not reached. For example, a major surface of the cover glass and/or polarizer coated with the anti-static coating can have a surface resistivity ranging from about 10⁵ to about 10¹¹ Ohm/sq, such as from about 10⁶ to about 10¹¹ Ohm/sq, from about 10⁷ to about 10¹⁰ Ohm/sq, or from about 10⁸ to about 10⁹ Ohm/sq, including all ranges and subranges therebetween.

In other embodiments, the devices disclosed herein can quickly dissipate electrostatic charge on the cover glass such that the electric field threshold for modulating the LC layer is not reached. For instance, the cover glass in such display devices may have an electrostatic discharge decay time constant of less than about 1 second, such as less than about 0.5 seconds, e.g., ranging from about 0.1 seconds to about 1 second (such as 0.1, 0.2, 0.3, 0.4, 0.5, 0.6, 0.7, 0.8, 0.9, or 1 second). The decay time constant may be calculated as the amount of time it takes the electrostatic charge to decay by a factor of 1/e (about 36.8% of the original amount). In additional embodiments, the anti-static coating on the cover glass and/or polarizer may quickly dissipate electrostatic charge such that an electrostatic charge generated on one major surface of the cover glass and/or polarizer is reduced to 0 V on the opposing major surface in one second or less, such as less than about 0.5 seconds, e.g., ranging from about 0.1 seconds to about 1 second (such as 0.1, 0.2, 0.3, 0.4, 0.5, 0.6, 0.7, 0.8, 0.9, or 1 second).

Also disclosed herein are methods for reducing mura in a touch-display device, the methods comprising positioning a polarizer between a cover glass and a liquid crystal layer and applying a coating comprising at least one anti-static agent to at least one major surface of the cover glass, at least one major surface of the polarizer, or both. According to various embodiments, the anti-static coating may be applied to the cover glass and/or polarizer as a solution, which can comprise at least one anti-static agent and at least one solvent. In non-limiting embodiments, the at least one solvent may be chosen from water and water-miscible solvents, e.g., dimethyl formamide (DMF), dimethyl sulfoxide (DMSO), N-methylpyrrolidone (NMP), and low molecular weight alcohols such as isopropyl alcohol (IPA). In further embodiments, the at least one solvent may not be chosen from organic solvents.

The concentration of the at least one anti-static agent in the solution can vary depending on the desired thickness and/or conductive properties of the coating. In various embodiments, the anti-static agent concentration can range from about 0.0001 wt % to about 50 wt %, such as from about 0.001 wt % to about 40 wt %, from about 0.01 wt % to about 30 wt %, from about 0.02 wt % to about 20 wt %, from about 0.03 wt % to about 10 wt %, from about 0.04 wt % to about 5 wt %, from about 0.05 wt % to about 2 wt %, from about 0.1 wt % to about 1 wt %, from about 0.2 wt % to about 0.9 wt %, from about 0.3 wt % to about 0.8 wt %, from about 0.4 wt % to about 0.7 wt %, or from about 0.5 wt % to about 0.6 wt %, including all ranges and subranges therebetween. Exemplary concentrations for Luviquat™ FC 550 in solution can include, but are not limited to, from about 0.02 wt % to about 5 wt %, such as from about 0.05 wt % to about 4 wt %, from about 0.1 wt % to about 3 wt %, from about 0.2 wt % to about 2 wt %, from about 0.3 wt % to about 1 wt %, from about 0.4 wt % to about 0.9 wt %, from about 0.5 wt % to about 0.8 wt %, or from about 0.6 wt % to about 0.7 wt %, including all ranges and subranges therebetween. Exemplary concentrations for ACL Staticide® in solution can include, but are not limited to, about 0.5 wt % (undiluted stock) or less, such as from about 0.05 wt % (90% diluted) to about 0.45 wt % (10% diluted), from about 0.1 wt % (80% diluted) to about 0.4 wt % (20% diluted), or from about 0.2 wt % (60% diluted) to about 0.3 wt % (40% diluted).

After applying the solution to the cover glass and/or polarizer, e.g., by dip coating, spray coating, roller coating, spin coating, and other like processes, the coated component may be dried to remove excess solvent. For instance, the coated polarizer and/or cover glass may be dried at room temperature or elevated temperatures up to about 200° C. for a time period ranging from about 10 seconds to about 6 hours, such as from about 30 seconds to about 5 hours, from about 1 minute to about 4 hours, from about 5 minutes to about 3 hours, from about 10 minutes to about 2 hours, from about 20 minutes to about 1 hour, or from about 30 minutes to 40 minutes, including all ranges and subranges therebetween.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method or device that comprises A+B+C include embodiments where a method or device consists of A+B+C and embodiments where a method or device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

### Example 1

### Sample Preparation

Cover Glass A: Luviquat™ FC 550 stock solution (40% active matter (A.M.) in water) was diluted in water to produce solutions with different concentrations ranging from 0.01 wt % to 2 wt % A.M. in water. Gorilla® Glass 3 and 5 samples were cleaned with a 1 wt % Semiclean KG solution and subsequently spin-rinse-dried. The Luviquat™ FC 500 solutions were spin coated onto the Gorilla® Glass samples using a two-step process: (a) 30 seconds at 500 rpm and (b) 90 seconds at 2000 rpm. After spin coating, the coated samples were baked for 2 minutes at 150° C. to remove excess water from the coatings.

Cover Glass B: ACL Staticide® stock solution (˜0.5 wt % A.M. in water) was used as-is or diluted with up to 50% water to produce solutions with different concentrations ranging from 0.25 wt % to 0.5 wt % A.M. in water. Gorilla® Glass 3 and 5 samples were cleaned with a 1 wt % Semiclean KG solution and subsequently spin-rinse-dried. The Staticide® solutions were spin coated onto the Gorilla® Glass samples using a two-step process: (a) 30 seconds at 500 rpm and (b) 90 seconds at 2000 rpm. After spin coating, the coated samples were baked for 10 minutes at 90° C. to remove excess solvent from the coatings.

Polarizer: Staticide® was diluted in water to produce solutions with different concentrations ranging from 0.25 wt % to 0.5 wt % A.M. in water. A polarizer comprising a polyvinyl alcohol (PVA) polarizing element sandwiched between two triacetyl cellulose (TAC) protective layers was cleaned by wiping with isopropyl alcohol (IPA). The Staticide® solutions were applied to the polarizers using a cotton swab. The coated samples were allowed to dry at room temperature to remove excess solvent from the coatings.

### Example 2

### Electrostatic Charge Measurements

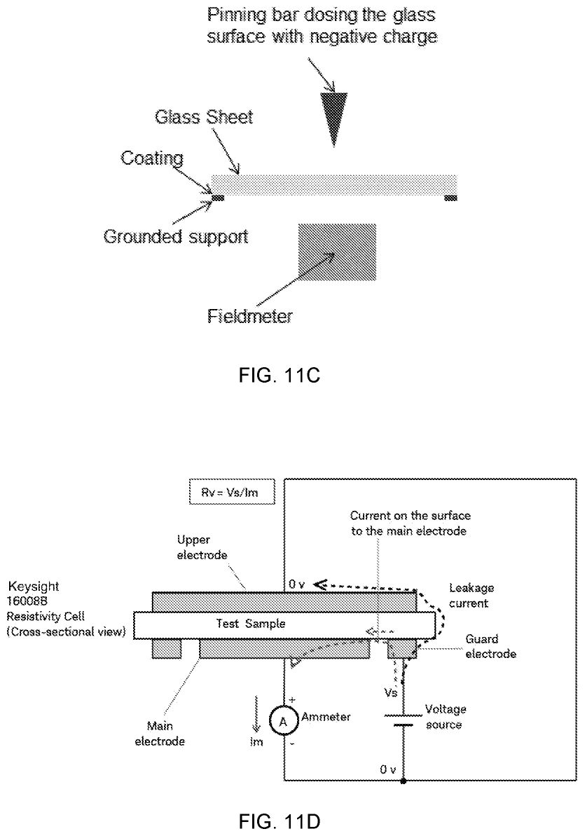

Coated and uncoated cover glass samples were tested for charge generation and charge dissipation using an electrostatic gauge (ESG). A stainless steel friction pad was connected to an electrometer that measures the total charge generated on the glass surface. The glass surface (charge generation area=20 mm×15 mm) was rubbed (load=0.3 lb; 5 cycles) while charging the puck equal and opposite to the glass and measuring the signal with the electrometer. The experimental set-up is illustrated in FIG. 11A.

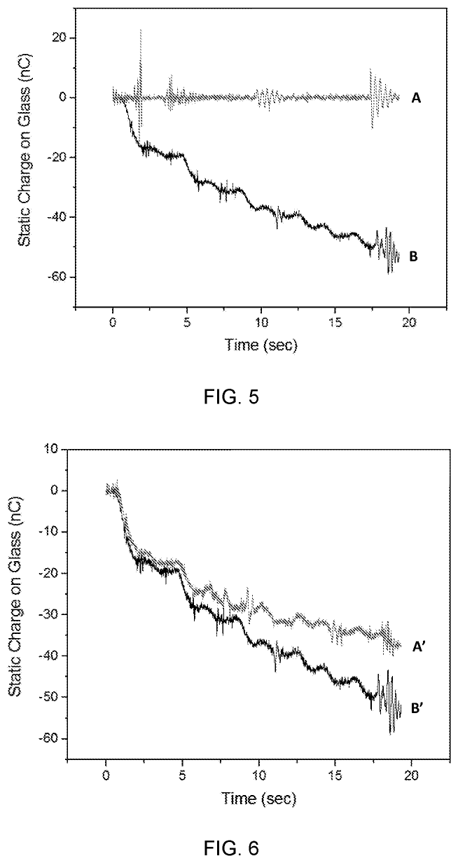

The results of these tests for a Gorilla® Glass 5 sample coated with a 0.2 wt % solution of Luviquat™ FC 550 are presented in FIGS. 5-6. Plots A and A′ represent a glass sample with an anti-static coating and plots B and B′ represents a glass sample without an anti-static coating. In FIG. 5, the coated surface of the glass was tribo-charged by rubbing to mimic a coating on the front surface of the cover glass, e.g., the surface contacted by the user. In the illustrated case, the anti-static coating dissipated the electrostatic charge generated on the coated surface so quickly that any accumulation was unobservable by the ESG (see plot A). In comparison, the electrostatic charge on the untreated glass surface continued to build-up over time (see plot B). In FIG. 6, the non-coated surface of the glass was tribo-charged by rubbing to mimic a coating on the rear surface of the cover glass, e.g., an internal surface not contacted by the user. It can be appreciated from this graph that the anti-static coating significantly reduced electrostatic charge build-up over time for the coated glass sample (plot A′) as compared to the untreated glass sample (plot B′).

The integrated surface voltage of coated and uncoated cover glass samples was tested using the ESG of Example 1. After 5 cycles of rubbing, a non-contact voltmeter was scanned over a raster area of 100 mm×50 mm for 10 consecutive rasters. Integrated surface voltage for each scan over the raster area was plotted versus time of the scan relative to the time the charge generation cycles ended. The experimental set-up is illustrated in FIG. 11B.

The results of these tests for Gorilla® Glass 3 and Gorilla® Glass 5 samples, respectively, are presented in FIGS. 7A-B. In FIG. 7A, plot C represents uncoated Gorilla® Glass 3, plot D represents Gorilla® Glass 3 coated with Luviquat™ FC 550 (0.2 wt %) on the rear (non-contact) surface, plot E represents Gorilla® Glass 3 coated with Staticide® (0.5 wt %) on the rear (non-contact) surface, and plot F represents Gorilla® Glass 3 coated with Luviquat™ FC 550 (0.2 wt %) on the front (contact) surface. In FIG. 7B, plot C′ represents uncoated Gorilla® Glass 5, plot D′ represents Gorilla® Glass 5 coated with Luviquat™ FC 550 (0.2 wt %) on the rear (non-contact) surface, and plot E′ represents Gorilla® Glass 5 coated with Staticide® (0.5 wt %) on the rear (non-contact) surface. For both glasses, the samples coated with Luviquat™ FC 550 and Staticide® show substantial reduction of voltage magnitude as compared to uncoated samples.

### Example 3

### Ion Dosing

Ion dosing was carried out to measure the electric field experienced inside an electronic device due to charge on the cover glass surface. Coated and uncoated cover glass samples (4 in.×4 in.) were placed over a grounded support frame with a corona discharge pinning bar positioned 1 cm above the center of the glass sample. The pinning bar ionizes the air around it, generating a negative charge underneath it, and imparting a negative charge over the glass in the vicinity of the bar. The pinning bar was held at 500 V for the first 20 seconds of the measurement. After 20 seconds, the ion dosing was stopped and the field generated from the residual charge was measured using an electrostatic field meter positioned 1 cm underneath the bottom of the glass sheet. Field measured on the field meter corresponds to electric field penetrating deep into the electronic device and potentially causing mura in a LC display device. The experimental set-up is illustrated in FIG. 11C.

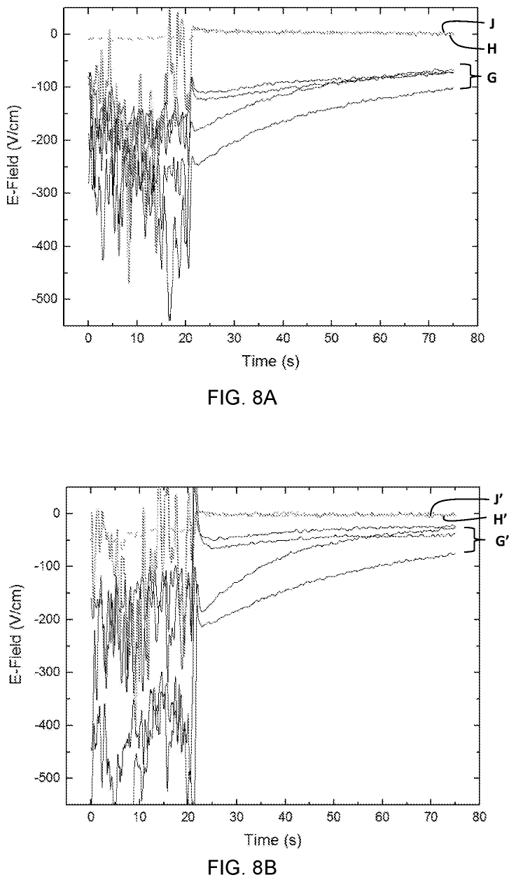

The results of these tests for Gorilla® Glass 3 and Gorilla® Glass 5 samples, respectively, are presented in FIGS. 8A-B. In FIG. 8A, plots G (solid lines) represent uncoated Gorilla® Glass 3 (4 samples), plot H (dotted line) represents Gorilla® Glass 3 coated with Luviquat™ FC 550 (0.2 wt %) on the rear (non-contact) surface, and plot J (dashed line) represents Gorilla® Glass 3 coated with Staticide® (0.5 wt %) on the rear (non-contact) surface. In FIG. 8B, plots G′ (solid lines) represent uncoated Gorilla® Glass 5 (4 samples), plot H′ (dotted line) represents Gorilla® Glass 5 coated with Luviquat™ FC 550 (0.2 wt %) on the rear (non-contact) surface, and plot J′ (dashed line) represents Gorilla® Glass 5 coated with Staticide® (0.5 wt %) on the rear (non-contact) surface. Whereas uncoated samples (plots G and G′) retained charge after the ion dosing was stopped (t=20 s) and the field maintained a non-zero value for a significant period of time, the samples coated with Luviquat™ FC 550 (plots H and H′) and Staticide™ (plots J and J′) dissipated the charge quickly and the measured field was reduced to zero almost instantaneously after the ion dosing was stopped (t=20 s).

### Example 4

### Film Thickness and Sheet Resistance

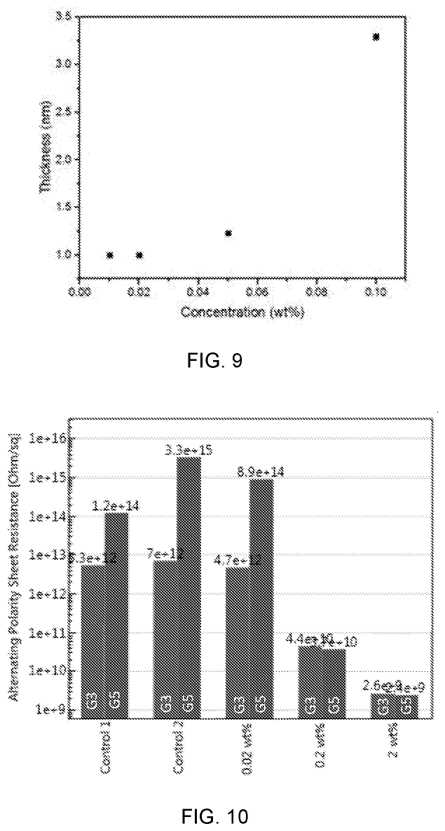

Film thickness for glass samples coated with 0.01 wt %, 0.02 wt %, and 0.1 wt % solutions of Luviquat™ FC 550 was measured by ellipsometry. The results of this testing are plotted in FIG. 9. Resistivity for two uncoated Gorilla® Glass 3 and 5 control samples and Gorilla® Glass 3 and 5 samples coated with 0.02 wt %, 0.2 wt %, and 2 wt % Luviquat™ FC 550 was measured using a Keysight B2987A electrometer. Using a Keysight 16008B Resistivity Cell fixture, the samples were pressed by 7 kg of force between two concentric electrodes with a perimeter of 188.5 mm and a gap of 10 mm between the inner and outer electrodes. The experimental set-up, as provided by Keysight, is illustrated in FIG. 11D.

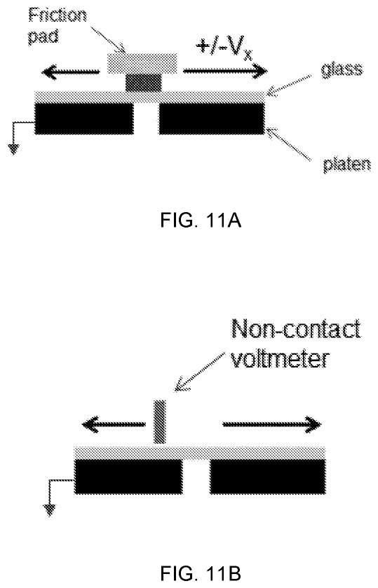

Resistivity was measured using an alternate polarity method in which the source voltage was changed from +20 V to −20 V approximately every 8 seconds. The difference in the values of the current right before switching the voltage polarity was used for deriving the sheet resistance. The results of this testing are provided in FIG. 10 and Table 1 below.

TABLE 1

| | Alternating Polarity Sheet Resistance |
|---|---|
| Sample | (Ohm/sq) |
| Control 1 G3 | 5.3e+12 |
| Control 1 G5 | 1.2e+14 |
| Control 2 G3 | 7e+12 |
| Control 2 G5 | 3.3e+15 |
| 0.02 wt % G3 | 4.7e+12 |
| 0.02 wt % G5 | 8.9e+14 |
| 0.2 wt % G3 | 4.4e+10 |
| 0.2 wt % G5 | 3.7e+10 |
| 2 wt % G3 | 2.6e+9 |
| 2 wt % G5 | 2.4e+9 |

As evidenced by Table 1 and the graph in FIG. 10, higher concentrations of anti-static agent result in greater decreases in sheet resistance. However, referring back to FIG. 9, the film thickness also increases significantly with increased concentration, indicating that these two factors may need to be balanced depending on the desired configuration.

### Example 5

### Mobile Device Integration (Cover Glass)

Coated cover glass samples were laminated to a LCD module using an optically clear adhesive (OCA) with the coated surface in contact with the OCA. The laminated module was autoclaved at 35° C. for an hour and subsequently integrated into a mobile device and tested for mura generation and dissipation as compared to uncoated samples. An electrostatic (ES) gun with an 8 mm conductive probe covered with an ethylene propylene diene monomer (EPDM) rubber sheath was used to contact the cover glass and a digital camera was used to record the device screen response. After a 10 kV single pulse application to induce localized mura, a module utilizing a Gorilla® Glass 3 coated with Luviquat™ FC 550 (0.2 wt %) made a full screen recovery within 648 microseconds. After five consecutive 10 kV pulse applications a module utilizing the module made a full screen recovery within 1 second, indicating an absence of image sticking. In contrast, the same pulse application to a module with uncoated cover glass resulted in significant image sticking.

### Example 6

### Mobile Device Integration (Polarizer)

Coated polarizer samples were laminated to a LCD module using an optically clear adhesive (OCA) between the cover glass and the coated surface of the polarizer. The laminated module was autoclaved at 35° C. for an hour and subsequently integrated into a mobile device and tested for mura generation and dissipation as compared to uncoated samples. The experimental procedure described in Example 5 was used. No mura was observed on the module screen after a 10 kV single pulse application by the ES gun.

1. A device comprising:
(a) a liquid crystal layer;
(b) a cover glass;
(c) a polarizer positioned between the liquid crystal layer and the cover glass; and
(d) a coating comprising at least one anti-static agent disposed on at least one major surface of the cover glass, at least one major surface of the polarizer, or both.

2. The device of claim 1, wherein the coating is disposed on at least a portion of at least one of a first major surface and a second major surface of the cover glass.

3. The device of claim 1, wherein the coating is disposed on at least a portion of at least one of a first major surface and a second major surface of the polarizer.

4. The device of claim 1, wherein the coating is disposed on at least one major surface of the cover glass and on at least one major surface of the polarizer.

5. The device of claim 1, wherein the coating has a thickness ranging from about 1 nm to about 5000 nm.

6. The device of claim 1, wherein the at least one anti-static agent is chosen from the group consisting of cationic polymers, anionic polymers, cationic polymers, anionic surfactants, and combinations thereof.

7. The device of claim 1, wherein the at least one anti-static agent is chosen from the group consisting of polycationic polymers, quaternary ammonium compounds, and combinations thereof.

8. The device of claim 1, further comprising a first adhesive layer positioned between the cover glass and the polarizer.

9. The device of claim 8, further comprising a second adhesive layer positioned between the polarizer and the liquid crystal layer.

10. The device claim 1, further comprising at least one of a receive (RX) sensor layer, a transmit (TX) sensor layer, a thin film transistor (TFT) array, a color filter glass, and a color filter.

11. The device of claim 1, wherein the device is a liquid crystal touch-display with an in-cell hybrid configuration.

12. The device of claim 1, further comprising an anti-fingerprint layer disposed on at least a portion of a first major surface of the cover glass.

13. The device of claim 1, wherein the cover glass has an electrostatic discharge decay time constant of less than about 1 second.

14. The device of claim 1, wherein the at least one major surface of the cover glass or the at least one major surface of the polarizer comprising the coating has a surface resistivity ranging from about 10⁵ to about 10¹¹ Ohm/sq.

15. A display, electronic, or lighting device comprising the device of claim 1.

16. A method for reducing mura in a touch-display device, the method comprising:
(a) positioning a polarizer between a cover glass and a liquid crystal layer; and
(b) applying a coating comprising at least one anti-static agent to at least one major surface of the cover glass, at least one major surface of the polarizer, or both.

17. The method of claim 16, wherein step (b) comprises applying a solution comprising the at least one anti-static agent and at least one solvent to the at least one major surface of the cover glass or the at least one major surface of the polarizer.

18. The method of claim 17, wherein a concentration of the at least one anti-static agent in the solution ranges from about 0.0001 wt % to about 50 wt %.

19. The method of claim 18, wherein step (b) further comprises drying the solution to remove the at least one solvent.

20. The method of claim 16, wherein the coating has a thickness ranging from about 1 nm to about 5000 nm.
